(19) United States
(12) Patent Application Publication
(10) Pub. No.: US 2025/0128500 A1
(43) Pub. Date: Apr. 24, 2025

(54) HIGH THERMAL CONDUCTIVITY COMPOSITE MATERIAL COMPRISING PAN-BASED CARBON FIBER AND PATTERNED GRAPHITE SHEET AND STITCHED WITH PITCH-BASED CARBON FIBER, AND METHOD FOR MANUFACTURING THE SAME

(71) Applicant: INDUSTRY-ACADEMIC COOPERATION FOUNDATION GYEONGSANG NATIONAL UNIVERSITY, Gyeongsangnam-do (KR)

(72) Inventors: Byeong Su KWAK, Gyeongsangnam-do (KR); Gyu Beom PARK, Gyeongsangnam-do (KR); Yeong Deok NOH, Gyeongsangnam-do (KR); Hun Cheol CHOI, Gyeongsangnam-do (KR); Jin Hwe KWEON, Gyeongsangnam-do (KR); Young Woo NAM, Gyeonggi-do (KR)

(73) Assignee: INDUSTRY-ACADEMIC COOPERATION FOUNDATION GYEONGSANG NATIONAL UNIVERSITY, Gyeongsangnam-do (KR)

(21) Appl. No.: 18/746,430

(22) Filed: Jun. 18, 2024

(30) Foreign Application Priority Data
Oct. 18, 2023 (KR) 10-2023-0139412

(51) Int. Cl. B32B 9/00; B32B 3/26; B32B 9/04; B32B 38/00

(52) U.S. Cl. CPC B32B 9/007; B32B 3/266; B32B 9/045; B32B 2038/0072; B32B 2038/0076; B32B 2250/40; B32B 2260/021; B32B 2260/046; B32B 2262/106; B32B 2305/076; B32B 2307/302; B32B 2307/7376; B32B 2309/02; B32B 2313/04; B32B 2363/00

(57) ABSTRACT

The present disclosure relates to a highly thermally conductive composite material including PAN-based carbon fiber and a patterned graphite sheet and stitched with pitch-based carbon fiber, and a method for manufacturing the same, and the highly thermally conductive composite material has excellent through-thickness thermal conductivity, in-plane thermal conductivity and compressive strength.

### TECHNICAL FIELD

The present disclosure claims priority to and the benefits of Korean Patent Application No. 10-2023-0139412, filed with the Korean Intellectual Property Office on Oct. 18, 2023, the entire contents of which are incorporated herein by reference.

The present disclosure relates to a highly thermally conductive composite material including PAN-based carbon fiber and a patterned graphite sheet and stitched with pitch-based carbon fiber, and a method for manufacturing the same.

### BACKGROUND ART

Carbon fiber reinforced plastic (CFRP) is used in various fields including transportation, construction, marine, electricity, electronics, aviation and space industries due to its excellent corrosion resistance, fatigue properties and lightness as well as excellent specific rigidity and specific strength.

Mostly commonly used polyacrylonitrile (PAN)-based carbon fiber reinforced plastic is manufactured using polyacrylonitrile and exhibits excellent strength and modulus, but has a problem of low thermal conductivity. In addition, pitch-based carbon fiber reinforced plastic is manufactured using petroleum pitch, is inexpensive, and exhibits excellent strength.

However, since a temperature rapidly changes in the space environment, heat needs to be quickly dissipated in order [symbol] =to secure structural stability of spacecraft, satellites and the like and to protect internal electronic devices.

Accordingly, there are needs for a composite material having excellent thermal conductivity while maintaining similar strength to existing carbon fiber reinforced plastic.

### DISCLOSURE

### Technical Problem

The present disclosure is directed to providing a composite material having excellent thermal conductivity and strength.

However, objects to be addressed by the present disclosure are not limited to the object mentioned above, and other objects not mentioned will be clearly appreciated by those skilled in the art from the following description.

### Technical Solution

According to one aspect of the present disclosure, there is provided a highly thermally conductive composite material including: two graphite sheets; a first laminate positioned between the graphite sheets, in which one or more prepregs including polyacrylonitrile-based carbon fiber and a thermosetting resin are laminated; one or more repeating units laminated between the graphite sheet and the first laminate; and a plurality of pitch-based carbon fibers penetrating the graphite sheet, the first laminate and the repeating unit in the lamination direction to have both ends protruding, wherein the repeating unit includes, sequentially from a direction adjacent to the first laminate, a graphite sheet having a plurality of through holes and a second laminate in which one or more prepregs including polyacrylonitrile-based carbon fiber and a thermosetting resin are laminated, and the protruding both ends of the pitch-based carbon fiber are bent in the direction of a surface of the highly thermally conductive composite material.

According to another aspect of the present disclosure, there is provided a method for manufacturing the highly thermally conductive composite material, the method including: laminating a first laminate on a first graphite sheet by laminating one or more prepregs including polyacrylonitrile-based carbon fiber and a thermosetting resin; laminating, on the first laminate, one or more repeating units including a graphite sheet having a plurality of through holes and a second laminate prepared by laminating one or more prepregs including polyacrylonitrile-based carbon fiber and a thermosetting resin; laminating a second graphite sheet on the repeating unit; stitching a plurality of pitch-based carbon fibers so as to penetrate the first graphite sheet, the first laminate, the repeating unit and the second graphite sheet in the lamination direction to have both ends protruding; and compressing and bending the protruding both ends of the pitch-based carbon fiber while heating and curing the stitched first graphite sheet, first laminate, repeating unit and second graphite sheet.

### Advantageous Effects

A highly thermally conductive composite material according to one embodiment of the present disclosure can have excellent through-thickness and in-plane thermal conductivity.

A highly thermally conductive composite material according to one embodiment of the present disclosure can have excellent compressive strength.

Effects of the present disclosure are not limited to the above-described effects, and effects not mentioned will be clearly appreciated by those skilled in the art from the present specification.

### BRIEF DESCRIPTION OF DRAWINGS

FIG. 1 is a partially cut perspective view schematically illustrating a highly thermally conductive composite material according to the present disclosure.

FIG. 2 is a side cross-sectional view schematically illustrating a highly thermally conductive composite material according to the present disclosure.

FIG. 3 schematically illustrates a graphite sheet having a plurality of through holes according to the present disclosure.

FIG. 4 shows results of measuring through-thickness thermal conductivity of highly thermally conductive composite materials manufactured in Example 1 and Comparative Example 1 to Comparative Example 5.

FIG. 5 shows results of measuring in-plane thermal conductivity of highly thermally conductive composite materials manufactured in Example 1 and Comparative Example 1 to Comparative Example 5.

FIG. 6 shows results of measuring compressive strength of highly thermally conductive composite materials manufactured in Example 1, Reference Example 1 and Comparative Example 1.

### MODE FOR INVENTION

In the present specification, a description of a certain part “including” certain constituents means that it may further include other constituents, and does not exclude other constituents unless particularly stated on the contrary.

Throughout the present specification, a unit “parts by weight” may mean a ratio of weight between each component.

Throughout the present specification, a term including ordinal numbers such as “first” and “second” is used for the purpose of distinguishing one constituent from another constituent, and is not limited by the ordinal numbers. For example, within the scope of a right of the disclosure, a first constituent may also be referred to as a second constituent, and similarly, a second constituent may be referred to as a first constituent.

Throughout the present specification, a “thickness direction” and a “lamination direction” represent a direction in which a prepreg is laminated to build up layers, and may specifically mean a direction from one surface where one prepreg and another prepreg are in contact with each other to the other surface of the one prepreg.

Throughout the present specification, an “in-plane direction” means a direction perpendicular to the thickness direction (lamination direction).

Hereinafter, constitutions for specific embodiments of the present disclosure will be described in detail as follows with reference to accompanying drawings. Herein, it needs to be noted that, in adding reference numerals to constituents in each drawing, the same numerals are used for the same constituents as possible even when they are shown in different drawings.

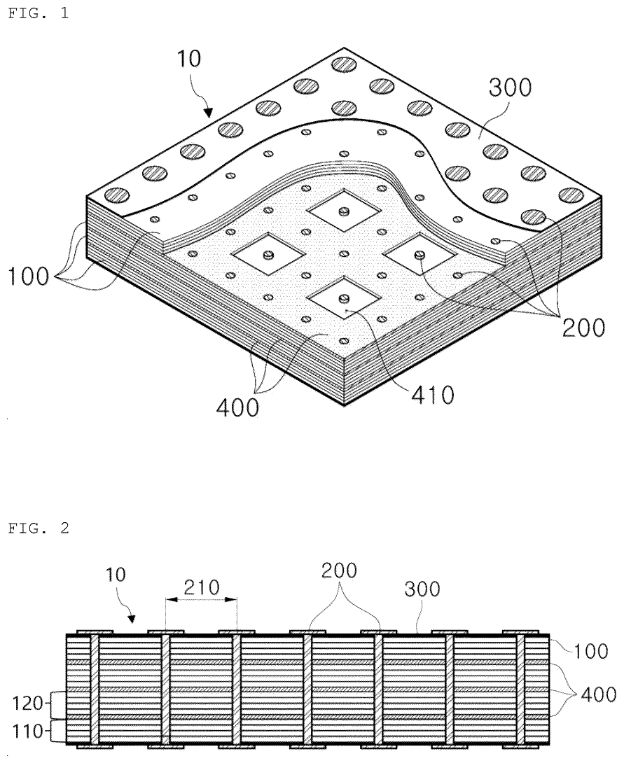

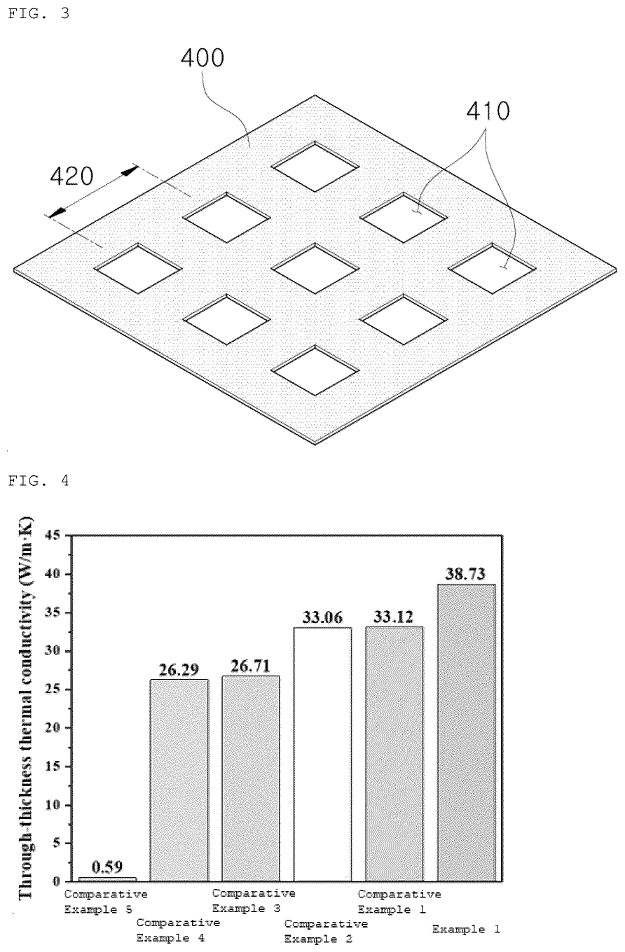

FIG. 1 is a partially cut perspective view schematically illustrating a highly thermally conductive composite material according to the present disclosure, and FIG. 2 is a side cross-sectional view schematically illustrating a highly thermally conductive composite material according to the present disclosure. In addition, FIG. 3 schematically illustrates a graphite sheet having a plurality of through holes according to the present disclosure.

Referring to FIG. 1, FIG. 2 and FIG. 3, a highly thermally conductive composite material 10 according to one embodiment of the present disclosure includes a prepreg 100, pitch-based carbon fiber 200, a graphite sheet 300 and a graphite sheet 400 having a plurality of through holes 410. Specifically, the highly thermally conductive composite material 10 includes two graphite sheets 300 with no separate through holes; a first laminate 110 in which one or more prepregs 100 are laminated between the two graphite sheets 300; one or more repeating units 120 laminated between the graphite sheet 300 and the first laminate 110; and a plurality of pitch-based carbon fibers 200 penetrating the graphite sheet, the first laminate and the repeating unit in the lamination direction to have both ends disposed at a predetermined interval 210 protruding. In addition, the repeating unit 120 includes, sequentially from a direction adjacent to the first laminate 110, a graphite sheet 400 having a plurality of through holes 410 formed at a predetermined interval 420, and a second laminate in which one or more prepregs 100 are laminated on the graphite sheet 400 having a plurality of through holes 410, and the protruding both ends of the pitch-based carbon fiber 200 are bent in the direction of a surface of the highly thermally conductive composite material 10 to have a radial shape. Furthermore, the prepreg 100 included in the first laminate 110 and the second laminate includes polyacrylonitrile-based carbon fiber and a thermosetting resin.

Accordingly, one embodiment of the present disclosure provides a highly thermally conductive composite material including: two graphite sheets; a first laminate positioned between the graphite sheets, in which one or more prepregs including polyacrylonitrile-based carbon fiber and a thermosetting resin are laminated; one or more repeating units laminated between the graphite sheet and the first laminate; and a plurality of pitch-based carbon fibers penetrating the graphite sheet, the first laminate and the repeating unit in the lamination direction to have both ends protruding, wherein the repeating unit includes, sequentially from a direction adjacent to the first laminate, a graphite sheet having a plurality of through holes and a second laminate in which one or more prepregs including polyacrylonitrile-based carbon fiber and a thermosetting resin are laminated, and the protruding both ends of the pitch-based carbon fiber are bent in the direction of a surface of the highly thermally conductive composite material.

The highly thermally conductive composite material according to one embodiment of the present disclosure may enhance through-thickness thermal conductivity by including a plurality of pitch-based carbon fibers penetrating the graphite sheet, the first laminate and the repeating unit in the lamination direction. In addition, by including a graphite sheet on the outermost surface of the highly thermally conductive composite material and including a graphite sheet having a plurality of through holes in the repeating unit, and by the protruding both ends of the pitch-based carbon fiber being bent in the direction of a surface of the highly thermally conductive composite material, in-plane thermal conductivity may be enhanced. Furthermore, by the pitch-based carbon fiber penetrating the graphite sheet, the first laminate and the repeating unit, and bent in the direction of a surface of the highly thermally conductive composite material, compressive strength of the highly thermally conductive composite material may be enhanced.

According to one embodiment of the present disclosure, the prepreg included in the first laminate and the prepreg included in the second laminate may each be laminated in the number of greater than or equal to 1 and less than or equal to 7. By laminating the prepregs in the first laminate and the second laminate in the above-described range, the highly thermally conductive composite material may have excellent through-thickness thermal conductivity, and excellent in-plane thermal conductivity and compressive strength. On the other hand, when more prepregs are laminated in the first laminate and the second laminate than the above-described range, the highly thermally conductive composite material may have decreased thermal conductivity.

According to one embodiment of the present disclosure, the plurality of through holes may be formed on the graphite sheet at an interval of greater than 3 mm and less than or equal to 30 mm. The interval means an interval between a middle position of one through hole and a middle position of another through hole. Specifically, the plurality of through holes may be formed on the graphite sheet at an interval of greater than 3 mm and less than or equal to 30 mm, 3 mm to 25 mm, 3 mm to 20 mm, 3 mm to 15 mm or 3 mm to 10 mm. By forming the plurality of through holes on the graphite sheet at an interval of the above-described range, through-thickness thermal conductivity, in-plane thermal conductivity and compressive strength of the highly thermally conductive composite material may be enhanced. More specifically, compressive strength may be enhanced by increasing the directly binding area of the prepreg including polyacrylonitrile-based carbon fiber through the plurality of through holes.

According to one embodiment of the present disclosure, the through hole may be formed on the graphite sheet in a polygonal shape such as a circle, an ellipse, a triangle or a square. However, the shape is not limited to the above-described shape.

According to one embodiment of the present disclosure, the plurality of pitch-based carbon fibers may penetrate at an interval of 3 mm to 15 mm. Specifically, the plurality of pitch-based carbon fibers may penetrate at an interval of 3 mm to 15 mm, 3 mm to 13 mm, 3 mm to 10 mm, 3 mm to 8 mm or 3 mm to 5 mm. When the plurality of pitch-based carbon fibers penetrate the graphite sheet, the first laminate and the repeating unit in the above-described range, through-thickness thermal conductivity and compressive strength of the highly thermally conductive composite material may be enhanced.

According to one embodiment of the present disclosure, the plurality of pitch-based carbon fibers may penetrate so as to pass through the through holes of the graphite sheet having a plurality of through holes. By the plurality of pitch-based carbon fibers penetrating the through holes as well as the non-penetrating portion of the graphite sheet having a plurality of through holes, empty portions (gaps) created by the through holes may be filled, and through-thickness thermal conductivity, in-plane thermal conductivity and compressive strength of the highly thermally conductive composite material may be enhanced.

According to one embodiment of the present disclosure, the thermosetting resin may be an epoxy resin. The epoxy resin may form an adhesive layer while being heated and cured. Using the above-described epoxy resin as the thermosetting resin may enhance interfacial binding force between the prepreg and the prepreg or between the prepreg and the graphite sheet, and accordingly, the highly thermally conductive composite material may have excellent strength.

According to one embodiment of the present disclosure, the prepreg including carbon fiber and a thermosetting resin may further include a curing agent. The prepreg may include a curing agent included in the thermosetting resin, or a separate curing agent may be further mixed thereto to be included. By the prepreg including a curing agent, the thermosetting resin may be readily cured.

According to one embodiment of the present disclosure, the prepreg may have a thickness of 0.1 mm to 10 mm. Specifically, the prepreg may have a thickness of 0.1 mm to 10 mm, 0.1 mm to 7 mm, 0.1 mm to 5 mm, 0.1 mm to 2 mm, 0.2 mm to 10 mm, 0.2 mm to 8 mm, 0.2 mm to 5 mm or 0.2 mm to 3 mm. When the prepreg has a thickness in the above-described range, the pitch-based carbon fiber may readily penetrate, and the highly thermally conductive composite material may have excellent compressive strength.

According to one embodiment of the present disclosure, the pitch-based carbon fiber is formed with a plurality of strands, and the protruding both ends of the pitch-based carbon fiber may be the plurality of strands being bent in a radial shape. As described above, by the plurality of strands of the protruding both ends of the pitch-based carbon fiber being bent in the direction of a surface of the highly thermally conductive composite material in a radial shape, a pitch-based carbon fiber layer may be formed on the outermost surface of the highly thermally conductive composite material. As a result, in-plane thermal conductivity of the highly thermally conductive composite material according to the present disclosure may be enhanced.

According to one embodiment of the present disclosure, lengths of the protruding both ends of the pitch-based carbon fiber may each be less than or equal to the interval between the plurality of pitch-based carbon fibers, and may be from 2 mm to 8 mm. Specifically, lengths of the protruding both ends of the pitch-based carbon fiber may each be from 2 mm to 8 mm, 2 mm to 5 mm, 2 mm to 3 mm, 3 mm to 8 mm, 3 mm to 7 mm, 3 mm to 6 mm, 3 mm to 5 mm or 3 mm to 4 mm, and may be less than or equal to the interval between the plurality of pitch-based carbon fibers. By satisfying the above-described condition, in-plane thermal conductivity and compressive strength of the highly thermally conductive composite material may be enhanced. On the other hand, when lengths of the protruding both ends of the pitch-based carbon fiber are shorter than the above-described range, the pitch-based carbon fiber bent in the direction of a surface of the highly thermally conductive composite material is not able to form a proper pitch-based carbon fiber layer on the outermost surface of the highly thermally conductive composite material, and in-plane thermal conductivity and compressive strength of the highly thermally conductive composite material may be reduced.

In addition, when the pitch-based carbon fiber penetrates the prepreg laminate, a portion of the thermosetting resin (epoxy resin) with low thermal conductivity included in the prepreg penetrates while being stained on the penetrating pitch-based carbon fiber. Accordingly, when lengths of the protruding both ends of the pitch-based carbon fiber are longer than the interval between the plurality of pitch-based carbon fibers, the thermosetting resin (epoxy resin) with low thermal conductivity may be excessively formed on the outermost surface of the highly thermally conductive composite material, and thermal conductivity of the highly thermally conductive composite material may be reduced.

One embodiment of the present disclosure provides a method for manufacturing the highly thermally conductive composite material, the method including: laminating a first laminate on a first graphite sheet by laminating one or more prepregs including polyacrylonitrile-based carbon fiber and a thermosetting resin; laminating, on the first laminate, one or more repeating units including a graphite sheet having a plurality of through holes and a second laminate prepared by laminating one or more prepregs including polyacrylonitrile-based carbon fiber and a thermosetting resin; laminating a second graphite sheet on the repeating unit; stitching a plurality of pitch-based carbon fibers so as to penetrate the first graphite sheet, the first laminate, the repeating unit and the second graphite sheet in the lamination direction to have both ends protruding; and compressing and bending the protruding both ends of the pitch-based carbon fiber while heating and curing the stitched first graphite sheet, first laminate, repeating unit and second graphite sheet.

According to one embodiment of the present disclosure, the curing may be performed by heating at a temperature of 50° C. to 150° C. Specifically, the curing may be performed by primary heating at 50° C. to 100° C., 50° C. to 90° C., 60° C. to 100° C., 60° C. to 80° C. or 70° C. to 90° C., and secondary heating at 100° C. to 150° C., 100° C. to 140° C., 100° C. to 130° C., 110° C. to 150° C., 110° C. to 140° C. or 110° C. to 130° C. By heating in the above-described temperature range, the thermosetting resin included in the prepreg may be readily cured.

Matters mentioned in the highly thermally conductive composite material and the method for manufacturing the highly thermally conductive composite material of the present disclosure apply equally unless they contradict each other.

Hereinafter, the present disclosure will be described in detail with reference to examples and experimental examples in order to specifically describe the present disclosure. However, examples and experimental examples according to the present disclosure may be modified to various different forms, and the scope of the present disclosure is not construed as being limited to the examples and the experimental examples described below. Examples and experimental examples of the present specification are provided in order to more fully describe the present disclosure to those having average knowledge in the art.

### Example 1. Manufacture of Highly Thermally Conductive Composite Material

A prepreg (PP, width 10 cm×height 10 cm×thickness 0.2 mm) including polyacrylonitrile (PAN)-based carbon fiber and a thermosetting resin (K51 epoxy resin), a graphite sheet (GS, width 10 cm×height 10 cm×thickness 0.025 mm), and a graphite sheet having through holes (width 3 cm×height 3 cm) formed at width and height intervals of 6 cm each (patterned graphite sheet, PGS, width 10 cm×height 10 cm×thickness 0.025 mm) were prepared. In the K51 epoxy resin, a certain amount of curing agent was included.

On one sheet of the prepared first graphite sheet, one sheet of the prepreg (first laminate) was laminated. On the first laminate, one sheet of the graphite sheet in which through holes are formed, and one sheet of the prepreg (second laminate) were sequentially laminated (repeating unit). Then, the repeating unit was repeatedly laminated so that there was a total of 8 sheets of the prepreg to prepare a third laminate. On the third laminate, one sheet of the second graphite was laminated to prepare a fourth laminate. A specific lamination order of the fourth laminate is GS/PP/PGS/PP/PGS/PP/PGS/PP/PGS/PP/PGS/PP/PGS/PP/PGS/PP/GS, and in the lamination order, PP represents the prepreg, GS represents the graphite sheet, PGS represents the graphite sheet with through holes, and the number shown as a subscript represents the number of prepreg lamination.

Into the fourth laminate in which the first graphite sheet, the first laminate, the repeating unit and the second graphite sheet are laminated, pitch-based carbon fibers were stitched so that width and height intervals are 3 mm each, and both ends of the pitch-based carbon fiber were each made to protrude 3 mm from the outermost surface of the final laminate. Herein, in the graphite sheet with through holes, the pitch-based carbon fiber was stitched into the portion with no penetration as well as the through holes.

The stitched fourth laminate was thermally cured by performing primary heating for 20 minutes at 80° C. and secondary heating for 120 minutes at 120° C. using an autoclave to manufacture a highly thermally conductive composite material. In addition, during the thermal curing process, the end of the pitch-based carbon fiber penetrating the fourth laminate was compressed at a pressure of 6 atm under vacuum to bend and fix in the direction of a surface of the highly thermally conductive composite material. Herein, a plurality of strands at the end of the pitch-based carbon fiber were bent in a radial shape.

### Comparative Example 1 to Comparative Example 5 and Reference Example 1

Highly thermally conductive composite materials of Comparative Example 1 to Comparative Example 5 and Reference Example 1 were manufactured in the same manner as in Example 1, except that the lamination order, the performing of stitching and the stitching interval were adjusted as in Table 1.

TABLE 1

| | | Performing | Stitching |
|---|---|---|---|
| | Lamination Order | of Stitching | Interval |
| Example 1 | GS/PP/PGS/PP/PGS/PP/PGS/ | ◯ | 3 mm |
| | PP/PGS/PP/PGS/PP/PGS/PP/ | | |
| | PGS/ PP/GS | | |
| Comparative | GS/PP/GS/PP/GS/PP/GS/PP/ | ◯ | 3 mm |
| Example 1 | GS/PP/GS/PP/GS/PP/GS/ | | |
| | PP/GS | | |
| Comparative | GS/PP₂/GS/PP₂/GS/PP₂/GS/ | ◯ | 3 mm |
| Example 2 | PP₂/GS | | |
| Comparative | GS/PP₄/GS/PP₄/GS | ◯ | 3 mm |
| Example 3 | | | |
| Comparative | GS/PP₈/GS | ◯ | 3 mm |
| Example 4 | | | |
| Comparative | PP₈ | X | — |
| Example 5 | | | |
| Reference | GS/PP/PGS/PP/PGS/PP/ | X | — |
| Example 1 | PGS/PP/PGS/PP/PGS/ | | |
| | PP/PGS/PP/PGS/PP/GS | | |

### Experimental Example 1. Measurement of Through-Thickness Thermal Conductivity of Highly Thermally Conductive Composite Material

For each of the highly thermally conductive composite materials manufactured in Example 1 and Comparative Example 1 to Comparative Example 5, thermal conductivity was measured in compliance with the ASTM E1461 standard, and the results are shown in FIG. 4.

Specifically, in-plane thermal diffusivity of each of the composite materials manufactured in the examples and the comparative examples was measured using LFA-467 (NETZSCH Group), and through-thickness thermal conductivity of the composite material was derived according to the following Mathematical Equation 1.

$$λ = α \times {C}_{p} \times ρ \qquad [ Mathematical Equation 1 ]$$

In Mathematical Equation 1, λ means thermal conductivity, α means thermal diffusivity, Cₚ means specific heat, and ρ means density.

Referring to FIG. 4, it was identified that Example 1 in which the graphite sheet with through holes was laminated had excellent through-thickness thermal conductivity compared to Comparative Example 1 to Comparative Example 5 in which the graphite sheet with through holes was not laminated.

### Experimental Example 2. Measurement of In-Plane Thermal Conductivity of Highly Thermally Conductive Composite Material

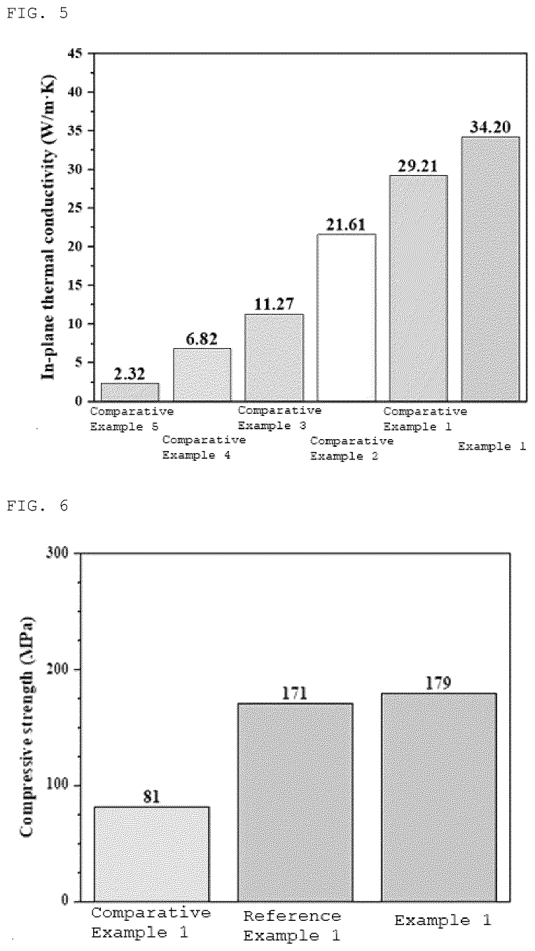

Thermal conductivity of each of the highly thermally conductive composite materials manufactured in Example 1 and Comparative Example 1 to Comparative Example 5 was measured in compliance with the ASTM E1461 standard, and the results are shown in FIG. 5.

Specifically, due to a problem that the thickness of each of the composite materials manufactured in the examples and the comparative examples was too thin to measure in-plane thermal diffusivity, the composite material was cut in the lamination direction, then the cut laminate was laminated again so that the total thickness becomes 10 mm, and then in-plane thermal diffusivity of the composite material was measured using LFA-467 (NETZSCH Group), and in-plane thermal conductivity of the composite material was derived according to Mathematical Equation 1.

Referring to FIG. 5, it was identified that Example 1 in which the graphite sheet with through holes was laminated had excellent in-plane thermal conductivity compared to Comparative Example 1 to Comparative Example 5 in which the graphite sheet with through holes was not laminated.

### Experimental Example 3. Evaluation of Compressive Strength

Compressive strength of each of the highly thermally conductive composite materials manufactured in Example 1, Reference Example 1 and Comparative Example 1 to Comparative Example 4 was measured in compliance with the ASTM D6641 standard, and the results are shown in FIG. 6.

Specifically, compressive strength was measured for each of the composite materials manufactured in the examples and the comparative example by applying a force inward in the in-plane direction at a head speed of 2 mm/min.

Referring to FIG. 6, it was identified that Example 1 and Reference Example 1 in which the graphite sheet with through holes was laminated had excellent compressive strength compared to Comparative Example 1 in which the graphite sheet with through holes was not laminated.

In addition, it was identified that Example 1 in which stitching was performed had excellent compressive strength compared to Reference Example 1 in which stitching was not performed.

Hereinbefore, the present disclosure has been described with limited examples, however, the present disclosure is not limited thereto, and it is obvious that various changes and modifications may be made by those skilled in the art within technical ideas of the present disclosure and the range of equivalents of the claims to be described.

### REFERENCE NUMERAL

10: Highly thermally conductive composite material
100: Prepreg
110: First laminate
120: Repeating unit
200: pitch-based carbon fiber having both ends protruding
210: Interval between pitch-based carbon fibers having both ends protruding
300: Graphite sheet
400: Graphite sheet with through holes
410: Through hole
420: Interval between through holes

1. A highly thermally conductive composite material comprising:
two graphite sheets;
a first laminate positioned between the graphite sheets, in which one or more prepregs including polyacrylonitrile-based carbon fiber and a thermosetting resin are laminated;
one or more repeating units laminated between the graphite sheet and the first laminate; and
a plurality of pitch-based carbon fibers penetrating the graphite sheet, the first laminate and the repeating unit in the lamination direction to have both ends protruding,
wherein the repeating unit includes, sequentially from a direction adjacent to the first laminate, a graphite sheet having a plurality of through holes, and a second laminate in which one or more prepregs including polyacrylonitrile-based carbon fiber and a thermosetting resin are laminated; and
the protruding both ends of the pitch-based carbon fiber are bent in a direction of a surface of the highly thermally conductive composite material.

2. The highly thermally conductive composite material of claim 1, wherein the prepreg included in the first laminate and the prepreg included in the second laminate are each laminated in a number of greater than or equal to 1 and less than or equal to 7.

3. The highly thermally conductive composite material of claim 1, wherein the plurality of through holes are formed on the graphite sheet at an interval of greater than 3 mm and less than or equal to 30 mm.

4. The highly thermally conductive composite material of claim 1, wherein the plurality of pitch-based carbon fibers penetrate at an interval of 3 mm to 15 mm.

5. The highly thermally conductive composite material of claim 1, wherein the thermosetting resin is an epoxy resin.

6. The highly thermally conductive composite material of claim 1, wherein the prepreg has a thickness of 0.1 mm to 10 mm.

7. The highly thermally conductive composite material of claim 1, wherein the pitch-based carbon fiber is formed with a plurality of strands, and the protruding both ends of the pitch-based carbon fiber are the plurality of strands being bent in a radial shape.

8. The highly thermally conductive composite material of claim 4, wherein lengths of the protruding both ends of the pitch-based carbon fiber are each less than or equal to an interval between the plurality of pitch-based carbon fibers, and are from 2 mm to 8 mm.

9. A method for manufacturing the highly thermally conductive composite material of claim 1, the method comprising:
laminating a first laminate on a first graphite sheet by laminating one or more prepregs including polyacrylonitrile-based carbon fiber and a thermosetting resin;
laminating, on the first laminate, one or more repeating units including a graphite sheet having a plurality of through holes, and a second laminate prepared by laminating one or more prepregs including polyacrylonitrile-based carbon fiber and a thermosetting resin;
laminating a second graphite sheet on the repeating unit;
stitching a plurality of pitch-based carbon fibers so as to penetrate the first graphite sheet, the first laminate, the repeating unit and the second graphite sheet in the lamination direction to have both ends protruding; and
compressing and bending the protruding both ends of the pitch-based carbon fiber while heating and curing the stitched first graphite sheet, first laminate, repeating unit and second graphite sheet.

10. The method of claim 9, wherein the curing is performed by heating at a temperature of 50° C. to 150° C.
